(19) United States
(12) Patent Application Publication
(10) Pub. No.: US 2005/0204530 A1
(43) Pub. Date: Sep. 22, 2005

(54) Fastener attachment tool

(76) Inventor: Carlos E. Ramirez, San Sebastian, PR (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/805,744

(22) Filed: Mar. 22, 2004

(51) Int. Cl. F16B 33/00

(52) U.S. Cl. 29/270

(57) ABSTRACT

In one embodiment, a fastener attachment tool includes an elongated shaft, the shaft comprising a tip that includes an opening that provides access to an elongated channel that is adapted to receive a stud to which a fastener is to be attached, the tip further including a gap that is adapted to receive and retain a flexible fastener to be attached to the stud.

### BACKGROUND

Fasteners such as nuts and bolts have been used for years to secure circuit boards within electronic devices such as computers. More recently, flexible fasteners have been introduced that are designed to be simply slid along the length of bolts, such that the bolts can be used to secure circuit boards without the need to thread nuts onto the bolts. Such coupling of the flexible fastener and the bolt enables more rapid securing of the circuit board.

An example of such a fastening arrangement is shown in FIG. 1. As is depicted in that figure, a bolt 100 is provided that includes a head 102 and a threaded stud 104 that extends from the head. As is suggested in FIG. 1, the bolt 100 can be passed through an opening 106 formed in a circuit board 108 so that a flexible fastener 110 can be pushed down the length of the threaded stud 104 and into abutment with a top surface 112 of the circuit board.

In the example of FIG. 1, the flexible fastener 106 is thin and round and includes an inner opening 114 through which the threaded stud 104 may pass. Accordingly, the flexible fastener 110 generally resembles a washer. Notches 116 are provided along the edges of the inner opening 114 that define tabs 118 that flex outwardly to accommodate the threaded stud 104 as it is passed through the opening. Those tabs 118 apply force against the threaded stud 104 and further engage threads of the stud to securely hold the fastener 106 in place along the length of the stud. Therefore, once the flexible fastener 110 is pushed along the length of the threaded stud 104 and into contact with the top surface 112 of the circuit board 108, the circuit board cannot move along the length of the stud (at least in the direction away from the head 102).

Although the above-described fastening arrangement is effective, it can be difficult to attach the flexible fastener 110 to the threaded stud 104. In the typical scenario, an assembler (a human being) first picks up the flexible fastener with his or her fingers. This alone can be difficult to do given that the flexible fastener is normally very small, for example only 1/4 inch in diameter. Next, the assembler manipulates the flexible fastener between his or her fingers into an appropriate position and then pushes the fastener onto the threaded stud. This task is also difficult given that, since the inner opening of the flexible fastener is normally smaller that the outer diameter of the threaded stud (in order to ensure a tight fit), a significant amount of force is needed to move the fastener down the length of the stud. Even if the assembler can push the flexible fastener along the threaded stud, it is easy for the assembler to cut his or her fingertips on the sharp threads of the stud.

Yet another difficulty relates to clearance. Specifically, if the circuit board is crowded with components adjacent the area that the flexible fastener is to be attached to a bolt, it may not be possible for the assembler to push the fastener all the way down the length of the threaded stud to the surface of the circuit board because there may not be enough room for this or her fingers. Therefore, in such a case, another solution must be contrived to urge the flexible fastener into its proper position.

### SUMMARY

In one embodiment, a fastener attachment tool includes an elongated shaft, the shaft comprising a tip that includes an opening that provides access to an elongated channel that is adapted to receive a stud to which a fastener is to be attached, the tip further including a gap that is adapted to receive and retain a flexible fastener to be attached to the stud.

### BRIEF DESCRIPTION OF THE DRAWINGS

The disclosed tool and its manner of use can be better understood with reference to the following drawings. The components in the drawings are not necessarily to scale.

FIG. 1 is an exploded perspective view of a prior art bolt and fastener that are used to secure a circuit board.

FIG. 2 is a perspective view of an embodiment of a fastener attachment tool.

FIG. 3 is an end view of the fastener attachment tool shown in FIG. 2.

FIG. 4 is a partial cross-sectional view of an embodiment of the shaft of the fastener attachment tool shown in FIGS. 2 and 3.

FIG. 5 is a partial cross-sectional view of the shaft of FIG. 4, shown with a flexible fastener retained in a tip of the shaft.

FIG. 6 is a partial cross-sectional view of the shaft of FIG. 4, shown with a flexible fastener retained in a tip of the shaft and being moved toward a bolt to which the fastener is to be attached.

FIG. 7 is a partial cross-sectional view of the shaft of FIG. 4, shown with a flexible fastener retained in a tip of the shaft being urged onto a threaded stud of a bolt.

FIGS. 8A-8D illustrate sequential steps of an embodiment of attaching a flexible fastener to a bolt using the fastener attachment tool shown in FIGS. 2 and 3.

### DETAILED DESCRIPTION

Disclosed is a fastener attachment tool that may be used to attach flexible fasteners to studs (e.g., threaded studs of bolts). As is described in the following, the tool can be used to pick up a flexible fastener and urge the fastener along the length of a threaded stud so that an assembler need not do so with his or her fingers.

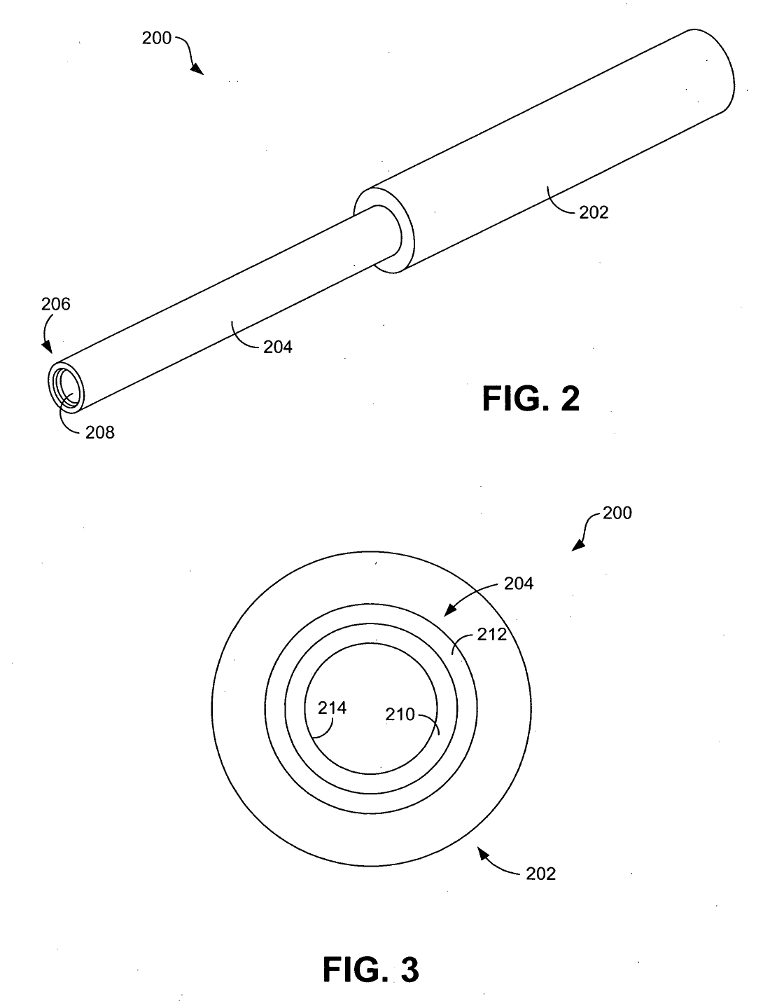

Referring now in more detail to the drawings, in which like numerals indicate corresponding parts throughout the several views, FIG. 2 illustrates a fastener attachment tool 200 that may be used to attach flexible fasteners to threaded studs. As is shown in FIG. 2, the tool 200 includes a handle 202 and an elongated shaft 204 that extends out from the handle. The handle 202 is sized and configured to be firmly and comfortably gripped by an assembler. Although the handle 202 is shown without any grooves or knurls, such features could be provided, if desired, to improve the assembler's ability to hold the tool 200.

The elongated shaft 204 includes an adjacent end and a distal end, the distal end comprising a tip 206 of the shaft. Formed in the tip 206 of the shaft 204 is an opening 208 that provides access to an elongated channel (see below) that extends along at least a portion of the length of the shaft. As is most clearly apparent from FIG. 3, the shaft 204 comprises an inner tube 210 and an outer tube 212 that surrounds the inner tube. The inner tube 210 forms the elongated channel 214 of the shaft and is made of a rigid material such as a metal (e.g., aluminum or steel). By way of example, the inner tube 210 has an inner diameter of approximately 3 millimeters and an outer diameter of approximately 6 millimeters.

In contrast, the outer tube 212 is constructed of a resilient material such as a plastic or rubber. In some embodiments, the outer tube 212 is constructed of polyurethane and has inner and outer diameters of approximately 6 and 8 millimeters, respectively (e.g., prior to being mounted on the inner tube 210). In addition to being resilient, the material used to construct the outer tube 212 is preferably electrically nonconductive to avoid delivery of a charge (e.g., electrostatic discharge) to or short circuit electronic components adjacent an area in which a flexible fastener is to be attached to a threaded stud.

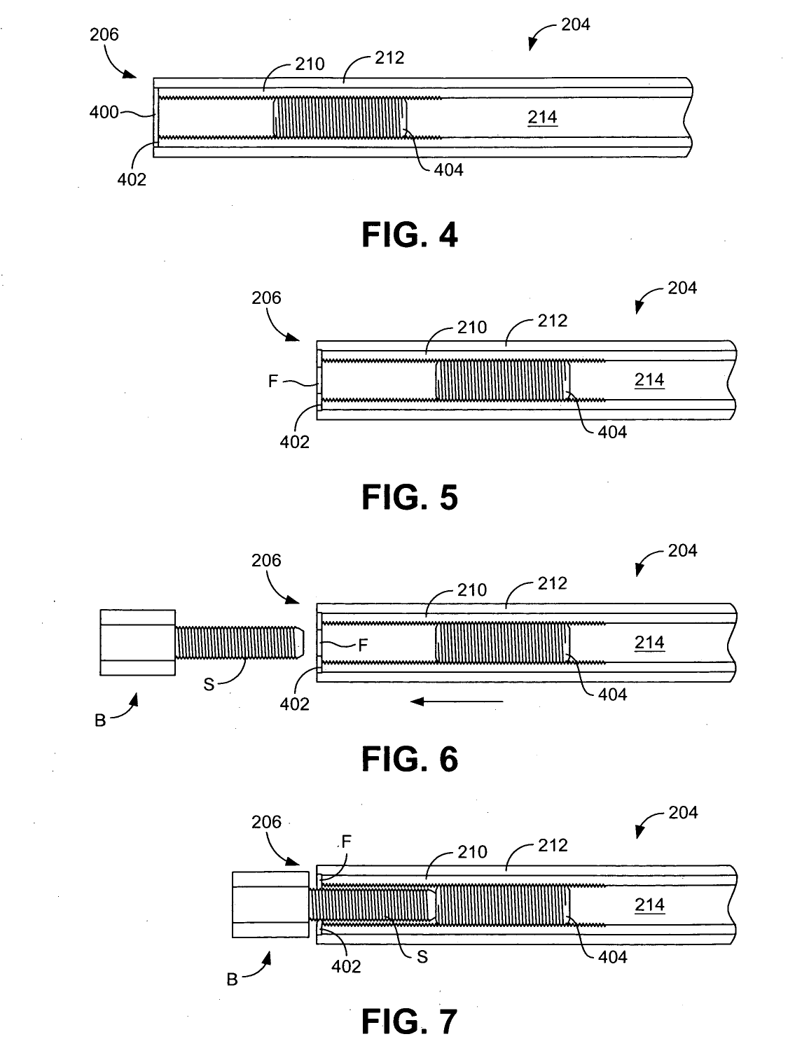

FIG. 4 illustrates a portion of the tool shaft 204 in cross-section. As is indicated in FIG. 4, the outer tube 212 extends beyond the end of the inner tube 210 at the tip 206 of the shaft 204 so as to define a space or gap 400 that, as is described below, is used to receive and retain a flexible fastener that is to be attached to a threaded stud. The gap 400 is defined by the inner surface of the outer tube 212 and an end face 402 of the inner tube 210. As is described in the following, the end face 402 is used to urge fasteners along the length of their associated studs when the tool 200 is used.

As is further indicated in FIG. 4, the elongated channel 214 of the inner tube 210 is at least partially threaded such that an adjustable stop 404 can be disposed within the channel and the axial position of the stop along the length of the shaft can be adjusted. By way of example, the adjustable stop 404 comprises a set screw that can be threaded along the length of the elongated channel 214 using, for instance, a hex key wrench. As is described below, the adjustable stop 404 can be used to limit the depth of insertion of a threaded stud into the channel 214 so that the end position of a flexible fastener along the length of the threaded stud can be controlled.

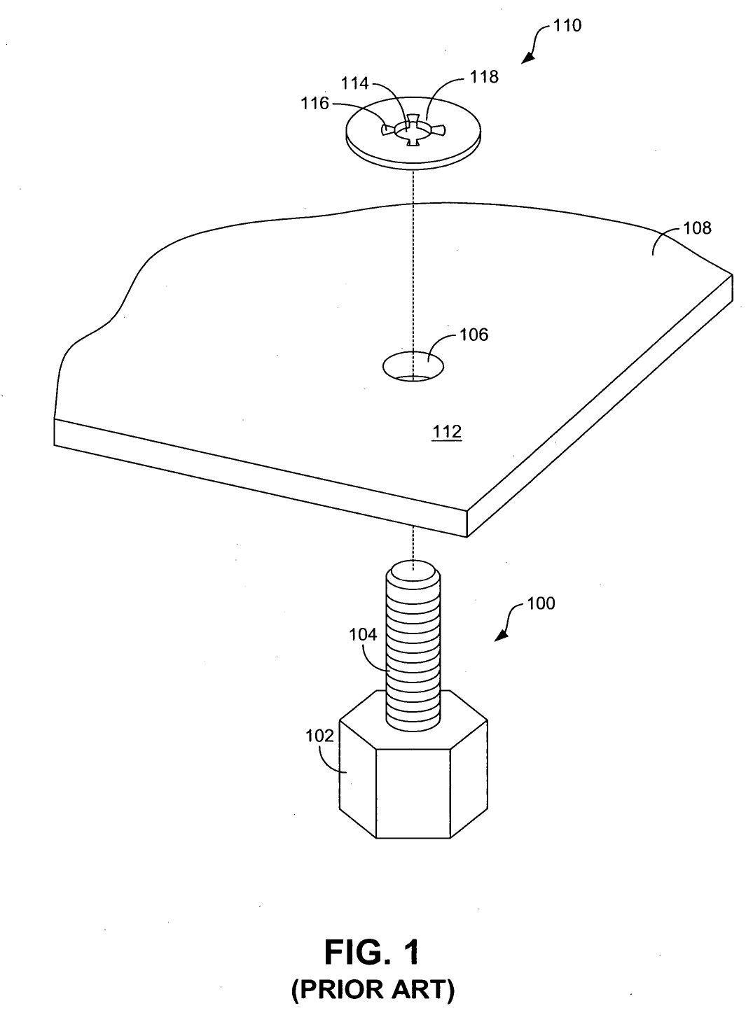

FIG. 5 illustrates a flexible fastener F retained in the gap 400 (FIG. 4) formed in the tip 206 of the tool shaft 204. As is indicated in FIG. 5, the outer diameter of the flexible fastener F is slightly larger that the inner diameter of the outer tube 212 (and therefore the gap 400) such that the outer tube expands to accommodate the fastener. This expansion is possible because of the resilience of the outer tube 212 and results in the fastener F being securely held within the tip 206 of the shaft 204. As is also apparent from FIG. 5, the fastener F abuts the end face 402 of the inner tube 210 when the fastener is disposed in the gap 402. This abutment with the rigid inner tube 210 enables the tool 200 to move the fastener F down the length of a threaded stud against the resistance provided by the threads of the stud and despite the inner opening (e.g., opening 114, FIG. 1) of the fastener being smaller than the outer diameter of the stud.

Referring next to FIG. 6, the tool 200 can be used to move the fastener F toward a bolt B to attach the fastener F to the bolt. As indicated in FIG. 7, a threaded stud S of the bolt B can be passed through the fastener F and into the elongated channel 214 of the tool shaft 204 so as to urge the fastener down the length of the threaded stud. Because the outer diameter of the flexible fastener F is larger than that of the inner diameter of the inner tube 210, the fastener is held in place within the gap 400 by the end face 402 of the inner tube as the threaded stud S passes into the elongated channel 214. As is apparent from FIG. 7, the diameter of the threaded stud S is smaller than the inner diameter of the inner tube 210 so that the stud can freely pass along the elongated channel 214 without engagement between the threads of the stud and the inner tube. As is also apparent in FIG. 7, the depth of insertion of the threaded stud S into the inner tube 210 is limited by the adjustable stop 404 so as to limit the travel of the flexible fastener F along the length of the stud.

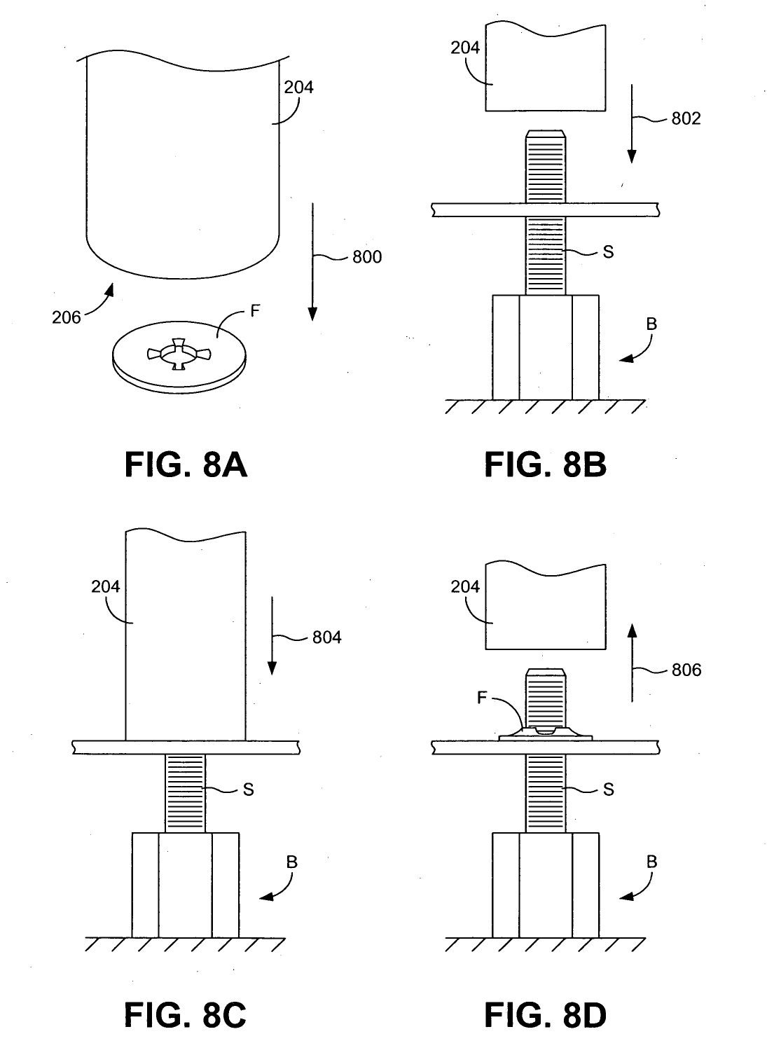

FIGS. 8A-8D illustrate sequential steps taken in attaching a flexible fastener F to a bolt B using the fastener attachment tool 200. Beginning with FIG. 8A, the fastener F is placed on a flat surface such as a table top. The shaft 204 of the tool 200 is then moved down toward the fastener F in the direction indicated by arrow 800 until the fastener is engaged by the tip 206 of the shaft and is positioned in the gap 400 (see FIG. 4) formed in the shaft tip. At this point, the fastener F is retained in the tip 206 of the shaft 204 (see FIG. 5) and may be picked up off of the flat surface.

Once the fastener F has been picked up, it can be moved into position above a bolt B, as indicated in FIG. 8B. By way of example, the bolt B extends through a circuit board CB that is to be secured by the bolt and the fastener. As is indicated in FIG. 8B, the bolt B may only partially extend through the circuit board CB in some cases. In such cases, it may be desirable to limit the depth of insertion of the bolt B (see description of FIG. 7 above) so as to avoid damaging the circuit board. The shaft 204 is moved toward the bolt B, as indicated by arrow 802.

Referring next to FIG. 8C, the shaft 204 is passed over the bolt B in the direction of arrow 804 so that its threaded stud S is received within the shaft. More particularly, the shaft 204 is passed over the bolt until contact is made between the shaft (and the outer tube 212 in particular) and the circuit board CB and, potentially, the tip of the stud S and the adjustable stop 404 (see FIG. 7).

At this point, the flexible fastener F has been urged down the length of the threaded stud S so that, when the shaft 203 is withdrawn, as indicated by arrow 806 in FIG. 8D, the fastener F surrounds the threaded stud S and contacts the circuit board CB. Accordingly, the fastener F can be quickly and easily attached to the bolt B without the need to pick up the fastener and force it down the length of the bolt with one's fingers.

1. A fastener attachment tool, comprising:
an elongated shaft, the shaft comprising a tip that includes an opening that provides access to an elongated channel that is adapted to receive a stud to which a fastener is to be attached, the tip further including a gap that is adapted to receive and retain the fastener to be attached to the stud;
wherein the fastener can be attached to the stud by first placing the fastener in the gap and then passing the shaft over the stud so that the stud passes through the fastener and into the elongated channel to urge the fastener down along the length of the stud.

2. The tool of claim 1, wherein the elongated shaft comprises a rigid inner tube and a resilient outer tube that surrounds the inner tube.

3. The tool of claim 2, wherein the resilient tube extends beyond the end of the inner tube so as to define the gap.

4. The tool of claim 3, wherein the gap is further defined by an end face of the inner tube.

5. The tool of claim 2, wherein the outer tube has an inner diameter that is smaller than the outer diameter of the fastener to be attached to the stud.

6. The tool of claim 2, wherein the outer tube is made of a plastic or rubber material.

7. The tool of claim 2, wherein the outer tube is made of polyurethane.

8. The tool of claim 2, wherein the inner tube is made of metal.

9. The tool of claim 2, wherein the elongated channel is formed with in the inner tube and is threaded.

10. The tool of claim 1, further comprising an adjustable stop that is provided within the elongated channel.

11. The tool of claim 1, further comprising a handle.

12. A fastener attachment tool, comprising:
an elongated shaft including a rigid inner tube that is surrounded by a resilient outer tube, the outer tube extending beyond the end of the inner tube so as to define a gap that is adapted to receive and retain a flexible fastener, the shaft further including an elongated channel that extends along at least part of the inner tube, the elongated channel being adapted to receive a stud to which the flexible fastener is to be attached;
wherein the flexible fastener can be attached to the stud by first placing the flexible fastener in the gap and then passing the shaft over the stud so that the stud passes through the flexible fastener and into the elongated channel to urge the flexible fastener down along the length of the stud.

13. The tool of claim 12, wherein the outer tube has an inner diameter that is smaller than the outer diameter of the flexible fastener to be attached to the stud.

14. The tool of claim 12, wherein the outer tube is made of a plastic or rubber material.

15. The tool of claim 12, wherein the outer tube is made of polyurethane.

16. The tool of claim 12, wherein the inner tube is made of metal.

17. The tool of claim 12, wherein the elongated channel is at least partially threaded.

18. The tool of claim 12, further comprising an adjustable stop that is provided within the elongated channel.

19. The tool of claim 18, wherein the adjustable stop is threaded into the elongated channel.

20. The tool of claim 12, further comprising a handle.

21. A fastener attachment tool, comprising:
a handle that may be used to grip the tool; and
an elongated shaft that extends out from the handle, the elongated shaft including a rigid inner tube having a threaded channel that is adapted to receive a threaded stud to which a flexible fastener is to be attached, the elongated shaft further including a resilient outer tube that surrounds the inner tube, the outer tube extending beyond the end of the inner tube so as to define a gap that is adapted to receive and retain the flexible fastener, the outer tube having an inner diameter that is smaller than the outer diameter of the flexible fastener that is to be retained, the elongated shaft further including an adjustable stop that is provided within the threaded channel of the inner tube, the adjustable stop being adapted to limit a depth of insertion of the threaded stud to which the flexible fastener is to be attached;
wherein the flexible fastener can be attached to the threaded stud by first placing the flexible fastener in the gap by pressing the shaft down over the flexible fastener and then passing the shaft over the threaded stud so that the stud passes through the flexible fastener and into the threaded channel to urge the flexible fastener down along the length of the stud against the resistance of its threads.
